(19) United States
(12) Patent Application Publication
(10) Pub. No.: US 2006/0149600 A1
(43) Pub. Date: Jul. 6, 2006

(54) Transferring image and patient data as a virtual print operation

(76) Inventors: Brian Cavanaugh, Pleasanton, CA (US); Chris Barnett, Livermore, CA (US); Chris Leitner, Peoria, AZ (US); Robert Herzberg, Milpitas, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/240,586

(22) Filed: Sep. 29, 2005

Related U.S. Application Data
(60) Provisional application No. 60/631,816, filed on Nov. 29, 2004.

(51) Int. Cl. G06F 19/00; G06K 9/00

(52) U.S. Cl. 705/3; 382/128

(57) ABSTRACT

A method, article of manufacture and apparatus for transferring image data is described. In one embodiment, the method comprises receiving a request to a print data corresponding to an image, displaying a user interface to enable identification of patient information corresponding to the image data, formatting the image data into a format, and sending formatted image data with the patient information to a medical imaging device.

This application claims the benefit of and incorporates by reference U.S. Provisional Application No. 60,631816 entitled “Print to Pacs,” filed Nov. 29, 2004.

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### FIELD OF THE INVENTION

The field of the invention is the transfer of images; more particularly, the field of the invention is the transfer of images in a particular format (e.g., DICOM) using a print driver.

### BACKGROUND

Medical imaging systems can store and display clinical images including Computed Tomography (CT), magnetic resonance imaging (MRI), X-ray, ultrasound, and images from many other modalities. This information is used by physicians for the diagnosis and treatment of their patients. Two common types of medical imaging systems include Picture Archive and Communication Systems (PACS) and Electronic Medical Record Systems (EMR).

Communication protocols have been developed for sending medical images from the acquisition device to a medical imaging system. The most popular is the Digital Imaging and Communication in Medicine (DICOM) ANSI standard. The DICOM Storage protocol provides the ability to send medical images from one device to another.

Although DICOM has been adopted by many medical imaging device companies, a number of software applications exist that do not support DICOM. These non-DICOM applications do not have a standard way to send their images to a medical imaging system and many are not traditional medical imaging applications. It is often useful, however, to store their output in a medical imaging system. For example, Microsoft Word is a non-medical application. Even so, a user may wish to store a report generated using Microsoft Word in a medical imaging system.

Devices have been developed to be positioned between a device generating an image or other output and an external medical imaging system. These devices act independently to reformat an image input for transfer using the DICOM protocol.

### SUMMARY OF THE INVENTION

A method, article of manufacture and apparatus for transferring image data is described. In one embodiment, the method comprises receiving a request to a print data corresponding to an image, displaying a user interface to enable identification of patient information corresponding to the image data, formatting the image data into a format, and sending formatted image data with the patient information to an imaging system.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a flow diagram of one embodiment of an environment in which a virtual point operation occurs.

FIG. 2 is one embodiment of an example of a user interface.

FIG. 3 is a flow diagram of one embodiment of a process for transferring image data.

FIG. 4 is a flow diagram of one embodiment of a process for entering information into a user interface using a look up operation.

FIG. 5 is a block diagram of one embodiment of a computer system.

FIG. 6 is a screen shot of a patient search window.

### DETAILED DESCRIPTION

A method and apparatus for sending data to a medical imaging system are described. One embodiment of the present invention comprises software, referred to herein as Print₂PACS™ software, that is operable to send data from a non-DICOM application to a system such as, for example, a medical imagining system, using the standard DICOM storage protocol. By acting as a virtual printer, the Print₂PACS software can receive data that is printed by a software application and reformat the data and transfer the data using the DICOM storage protocol. In one embodiment, the image data output from the software application is passed to software as a bitmap of image pixels. A driver of the Print₂PACS software complies with the operating systems specification for print driver software and processes the image pixels to enable them to transfer under the DICOM protocol.

As part of processing image data (e.g., pixels), in one embodiment, the software enables patient information (e.g., name, study, date, etc.) to be added to the file with the image data. The patient information may be specified using a user interface. In one embodiment, the user interface allows for searching of patients (e.g., patent name, patient ID) to obtain patient information to be sent with the image data.

In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

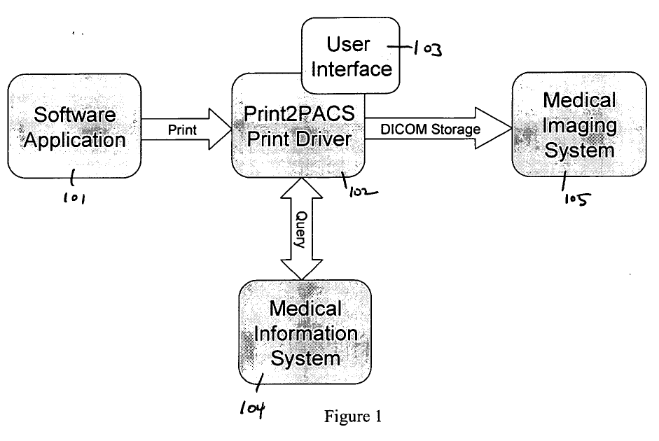

FIG. 1 is a block diagram showing a data flow for one embodiment of the Print₂PACS software. Referring to FIG. 1, a software application 101 uses its native print function to print an image, document, or any other information. By selecting the Print₂PACS software as a destination, the print information (e.g., image data or pixels) is passed to Print₂PACS print driver 102. Print₂PACS driver 102 emulates a standard printer by being registered in the system as a standard print software driver.

Once the printed data is received by Print₂PACS driver 102, the user optionally identifies the appropriate patient information associated with the print data. In one embodiment, the patent information comprises a patient name (or ID) and study. In one embodiment, the process of identifying the appropriate patient information can be done in two ways. The user can manually enter patient information directly into a user interface, such as, for example, Print₂PACS user interface 103. That is, by using Print₂PACS user interface 103, a user can specify the patient information.

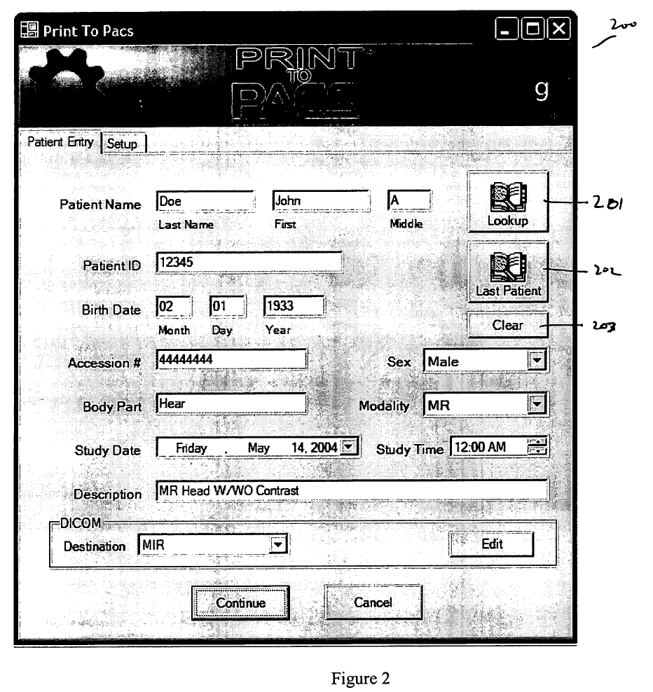

FIG. 2 illustrates an example of user interface. Referring to FIG. 2, user interface 200 includes a number of input boxes to input patient information. In one embodiment, the patient information includes patient name (last name, first name, middle name), patient ID, birth date, accession number, sex, body part, modality, study date, study time, and description. In one embodiment, there is a look-up button 201 to facilitate looking up patients that's described herein. In one embodiment, user interface 200 includes a last patient button 202 that inputs patient information associated with the last patient printed, such that by pressing button 202 one or more (or all) of the patient information on user interface 103 is automatically filled in. Clear button 203 clears all patient information. The DICOM box allows the user to select, from a configured list of DICOM devices, a device to which send the image data. The setup box allows these to be configured along with other configuration.

In addition, the user can query a medical information system 104 that contains patient information. In other words, to save time and assure that the data is correct, one embodiment of Print₂PACS software device 102 provides the ability to query an external system, such as medical information system 104, that already contains the correct patient and study information. In one embodiment, Print₂PACS software device 102 uses the same functionality used in medical information systems responsible for the management of non-imaging patient records, including admission information and departmental schedules. A number of medical imaging systems provide a query interface so that external systems can request and receive patient information. In one embodiment, it is through this interface that Print₂PACS software device 102 queries for patient identifying information that will be attached to the print images when they are sent to medical imaging system.

In one embodiment, the basis for the query is defined by entering data into one or more fields shown in FIG. 2, and then selecting lookup button 201. For example, the user may enter the letter B in the last name field, and all of the patients in the information system starting with the letter B will be returned. Similarly, they may enter a patient ID or accession number, and use lookup button 201 to retrieve all of the matching entries.

This query can be accomplished by one of a number of standard protocols. The DICOM Modality Worklist protocol can be used for any DICOM Compliant worklist provider on the system. In the DICOM Modality Worklist protocol, the query information entered in the user interface is passed to the DICOM Worklist provider, and all matching responses are shown. When DICOM Worklist is not available, some information systems provide a query interface via XML over HTTP, or via standard SQL database calls. Again, the query criteria entered into the user interface is passed to the information system in the query, and all of the matching responses will be returned.

Once the patient information has been entered manually or via an external query, Print₂PACS print driver 102 creates one or more DICOM compliant images and sends them to a medical imaging system 105 via the DICOM Storage protocol (e.g., DICOM Secondary Capture Storage Protocol). The DICOM storage protocol is well-known in the art.

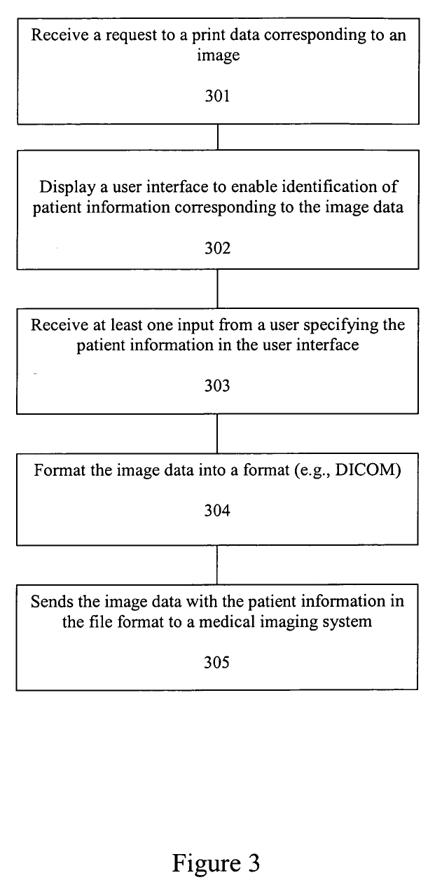

FIG. 3 is a flow diagram of one embodiment of a process for transferring image data. The process may be performed by processing logic that may comprise hardware (e.g., circuitry, dedicated logic, programmable logic, microcode, etc.), software (such as run on a general purpose computer system or a dedicated machine), or a combination of both. In one embodiment, the process is performed by print driver 102 shown in FIG. 1.

Referring to FIG. 3, the process begins by processing logic receiving a request to a print data corresponding to an image (processing block 301). A user may make this request by selecting an option from a pull down menu on a user interface on a display, clicking on a button or other icon appearing on the display.

In response to receiving a request to print, processing logic displays a user interface, such as, for example, user interface 103 of FIG. 1 or user interface 200 of FIG. 2, to enable identification of patient information corresponding to the image data (processing block 302).

From the user interface, processing logic receives at least one input from a user specifying the patient information in the user interface (processing block 303). In one embodiment, the patient information comprises a patient name and study.

The user may enter the patient information directly into boxes or other designated areas of the user interface or have boxes and/or other designated areas automatically filled through a patient look up.

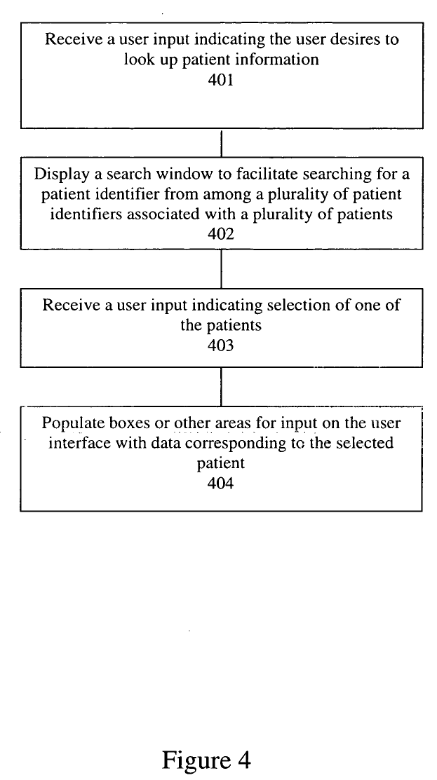

FIG. 4 is a flow diagram of one embodiment of a process for entering information into a user interface using a look up operation. The process may be performed by processing logic that may comprise hardware (e.g., circuitry, dedicated logic, programmable logic, microcode, etc.), software (such as run on a general purpose computer system or a dedicated machine), or a combination of both. In one embodiment, the process is performed by print driver 102 shown in FIG. 1.

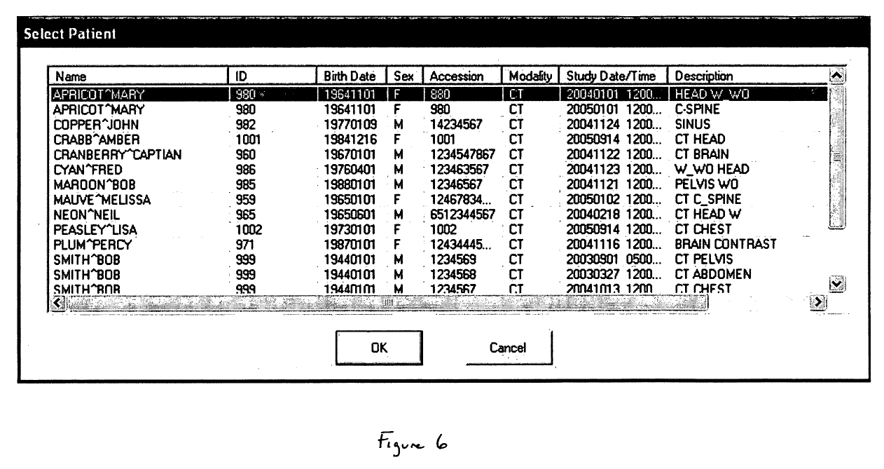

Referring to FIG. 4, the process begins by processing logic receiving a user input indicating the user desires to look up patient information (processing block 401). Next, processing logic displays a search window to facilitate searching for a patient identifier from among a plurality of patient identifiers associated with a plurality of patients (processing block 402). FIG. 6 illustrates a screen shot of one embodiment of this window. In one embodiment, the patient identifier comprises one or more of a group consisting of a patient name and a patient ID. Then, processing logic receives a user input indicating selection of one of the patients (processing block 403). In response to the input, processing logic populates boxes or other areas for input on the user interface with data corresponding to the selected patient (processing block 404).

Referring back to FIG. 3, after receiving the user information, processing logic formats the image data into a format (processing block 304). The formatting may include creating a file having the patient information and the image data with the file having a file format. In one embodiment, the format comprises the DICOM format.

After formatting, processing logic sends the image data with the patient information in the file format to a virtual printer location (processing block 305).

An Example of a Computer System

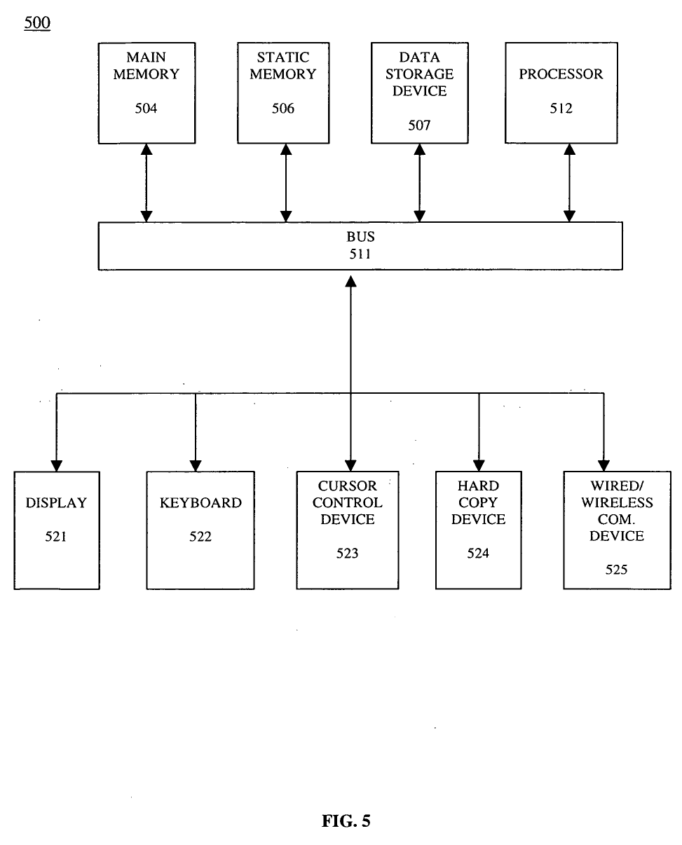

FIG. 5 is a block diagram of an example of a computer system that may perform one or more of the operations described herein. Referring to FIG. 5, computer system 500 may comprise an exemplary client or server computer system. Computer system 500 comprises a communication mechanism or bus 511 for communicating information, and a processor 512 coupled with bus 511 for processing information. Processor 512 includes a microprocessor, but is not limited to a microprocessor, such as, for example, Pentium™, PowerPC™, Alpha™, etc.

System 500 further comprises a random access memory (RAM), or other dynamic storage device 504 (referred to as main memory) coupled to bus 511 for storing information and instructions to be executed by processor 512. Main memory 504 also may be used for storing temporary variables or other intermediate information during execution of instructions by processor 512.

Computer system 500 also comprises a read only memory (ROM) and/or other static storage device 506 coupled to bus 511 for storing static information and instructions for processor 512, and a data storage device 507, such as a magnetic disk or optical disk and its corresponding disk drive. Data storage device 507 is coupled to bus 511 for storing information and instructions.

Computer system 500 may further be coupled to a display device 521, such as a cathode ray tube (CRT) or liquid crystal display (LCD), coupled to bus 511 for displaying information to a computer user. An alphanumeric input device 522, including alphanumeric and other keys, may also be coupled to bus 511 for communicating information and command selections to processor 512. An additional user input device is cursor control 523, such as a mouse, trackball, trackpad, stylus, or cursor direction keys, coupled to bus 511 for communicating direction information and command selections to processor 512, and for controlling cursor movement on display 521.

Another device that may be coupled to bus 511 is hard copy device 524, which may be used for printing instructions, data, or other information on a medium such as paper, film, or similar types of media. Furthermore, a sound recording and playback device, such as a speaker and/or microphone may optionally be coupled to bus 511 for audio interfacing with computer system 500. Another device that may be coupled to bus 511 is a wired/wireless communication capability 525 to communication to a phone or handheld palm device.

Note that any or all of the components of system 500 and associated hardware may be used in the present invention. However, it can be appreciated that other configurations of the computer system may include some or all of the devices.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. A method comprising:
receiving a request to a print data corresponding to an image;
displaying a user interface to enable identification of patient information corresponding to the image data;
formatting the image data into a format; and
sending formatted image data with the patient information to a medical imaging system.

2. The method defined in claim 1 further comprising receiving at least one input from a user specifying the patient information in the user interface.

3. The method defined in claim 1 wherein the patient information comprises a patient name and study.

4. The method defined in claim 1 further comprising:
receiving a user input indicating the user desires to look up patient information;
displaying a search window to facilitate searching for a patient identifier from among a plurality of patient identifiers associated with a plurality of patients; and
populating the user interface with data corresponding to the selected patient, at least part of the data corresponding to the selected patient being the patient information.

5. The method defined in claim 4 wherein the patient identifier comprises one or more of a group consisting of a patient name and a patient ID.

6. The method defined in claim 1 wherein the format is DICOM.

7. A method comprising:
receiving a request to a print data corresponding to an image;
displaying a user interface to enable identification of patient information corresponding to the image data;
receiving at least one input specifying the patient information in the user interface;
formatting the image data into the DICOM format; and
sending formatted image data with the patient information to a medical imaging system.

8. The method defined in claim 1 wherein the patient information comprises a patient name and study.

9. The method defined in claim 1 wherein receiving at least one input from a user specifying the patient information in the user interface comprises:
receiving a user input indicating the user desires to look up patient information;
displaying a search window to facilitate searching for a patient identifier from among a plurality of patient identifiers associated with a plurality of patients; and
populating the user interface with data corresponding to the selected patient, at least part of the data corresponding to the selected patient being the patient information.

10. The method defined in claim 9 wherein the patient identifier comprises one or more of a group consisting of a patient name and patient ID.

11. The method defined in claim 7 further comprising combining the patient information and image data into a file in the DICOM format.

12. An article of manufacture having one or more recordable media storing an instruction thereon which, when executed, cause a system to perform a method comprising:
receiving a request to a print data corresponding to an image;
displaying a user interface to enable identification of patient information corresponding to the image data;
formatting the image data into a format; and
sending formatted image data with the patient information to a medical imaging system.

13. The article of manufacture defined in claim 12 further comprising receiving at least one input from a user specifying the patient information in the user interface.

14. The article of manufacture defined in claim 12 wherein the patient information comprises a patient name and study.

15. The article of manufacture defined in claim 12 further comprising:
receiving a user input indicating the user desires to look up patient information;
displaying a search window to facilitate searching for a patient identifier from among a plurality of patient identifiers associated with a plurality of patients; and
populating the user interface with data corresponding to the selected patient, at least part of the data corresponding to the selected patient being the patient information.

16. The article of manufacture defined in claim 15 wherein the patient identifier comprises one or more of a group consisting of a patient name and a patient ID.

17. The method defined in claim 12 further comprising receiving an input from a user specifying the format in the user interface.
